(19) United States
(12) Patent Application Publication
(10) Pub. No.: US 2015/0176767 A1
(43) Pub. Date: Jun. 25, 2015

(54) CONDENSATION REDUCTION AROUND CRYOGENIC SERVICE CONNECTION

(71) Applicant: Hamilton Sundstrand Space Systems International, Inc., Windsor Locks, CT (US)

(72) Inventor: Jorge E. Hidalgo, Suffield, CT (US)

(73) Assignee: Hamilton Sundstrand Space Systems International, Inc., Windsor Locks, CT (US)

(21) Appl. No.: 14/171,835

(22) Filed: Feb. 4, 2014

Related U.S. Application Data
(60) Provisional application No. 61/919,857, filed on Dec. 23, 2013.

(51) Int. Cl. F17C 13/04; H01M 8/04; F17C 7/02

(52) U.S. Cl. CPC F17C 13/04; F17C 7/02; H01M 8/04029

(57) ABSTRACT

The system has a cryogenic tank and a connection for supplying a first fluid to the cryogenic tank. The fluid connection is provided with at least one valve which may be selectively opened to receive the fluid and one valve for venting. A vacuum chamber housing is positioned on an opposed side of the valve from the tank. A vacuum source is operated to remove leaking fluid from the vacuum housing while the first fluid is being supplied through the valve to the tank in order to minimize heat leaks to the transfer tube. A method is also disclosed.

### RELATED APPLICATION

This application claims priority to U.S. Provisional Application No. 61/919,857, filed Dec. 23, 2013.

### STATEMENT REGARDING FEDERALLY SPONSORED RESEARCH OR DEVELOPMENT

This invention was made with government support under Contract No. N00014-12-D-0372-0001 awarded by the United States Navy. The Government has certain rights in this invention.

### BACKGROUND OF THE INVENTION

This application relates to a structure and method for reducing condensation about a cryogenic service connection.

Cryogenic fluids are utilized in any number of applications.

In one application, hydrogen and oxygen may be stored on a vehicle having fuel cells. At a service location, the hydrogen and oxygen tanks must be refilled. Typically, there is a vent connection and a supply connection. Bayonet couplings include a valve biased to close each of the two connections.

When the tank is being filled, both of the bayonet valves are moved to open positions and a fluid is supplied into a tank through one connection, while a second connection allows air or other gases to vent outwardly of the tank.

There are challenges in the prior art in that leakage or remaining fluid around the valve can freeze after disconnection from the service connection. This can damage the valve and can result in leakage or interfere with future refuelling.

### SUMMARY OF THE INVENTION

The system has a cryogenic tank and a connection for supplying a fluid to the cryogenic tank. The fluid connection is provided with at least one valve which may be selectively opened to receive the fluid. A vacuum chamber housing is positioned on an opposed side of the valve from the tank. A vacuum source is operated to remove fluid from the vacuum housing while fluid is being supplied through the valve to the tank. A method is also disclosed.

These and other features may be best understood from the following drawings and specification.

### BRIEF DESCRIPTION OF THE DRAWINGS

FIG. 1 schematically shows a vehicle incorporating a service connection.

FIG. 2 shows a refilling step.

FIG. 3 shows a subsequent step.

FIG. 4 shows another embodiment.

### DETAILED DESCRIPTION

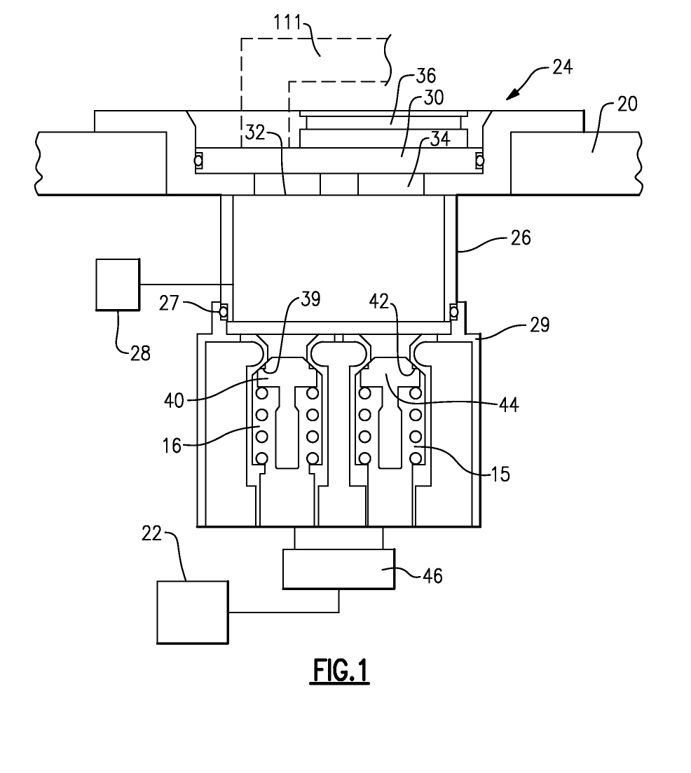

FIG. 1 shows a system 20 which may be a vehicle such as an underwater unmanned vehicle. Fuel cells 22 are shown schematically and communicate with a fluid tank 46. Typically, a fuel cell 22 would communicate with a source of hydrogen fuel and with a source of oxygen.

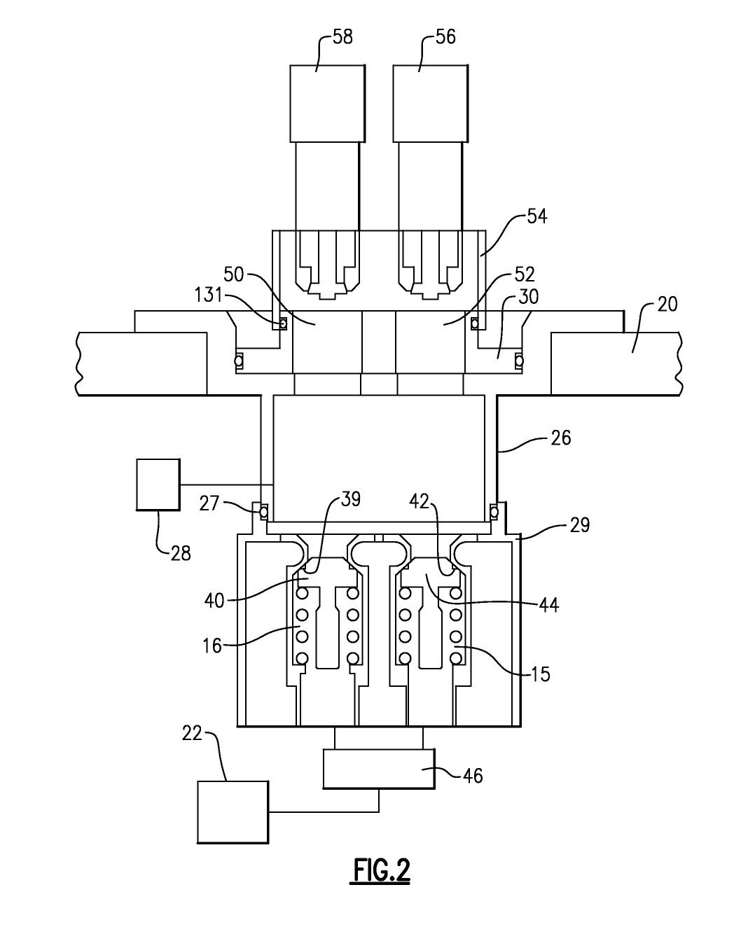

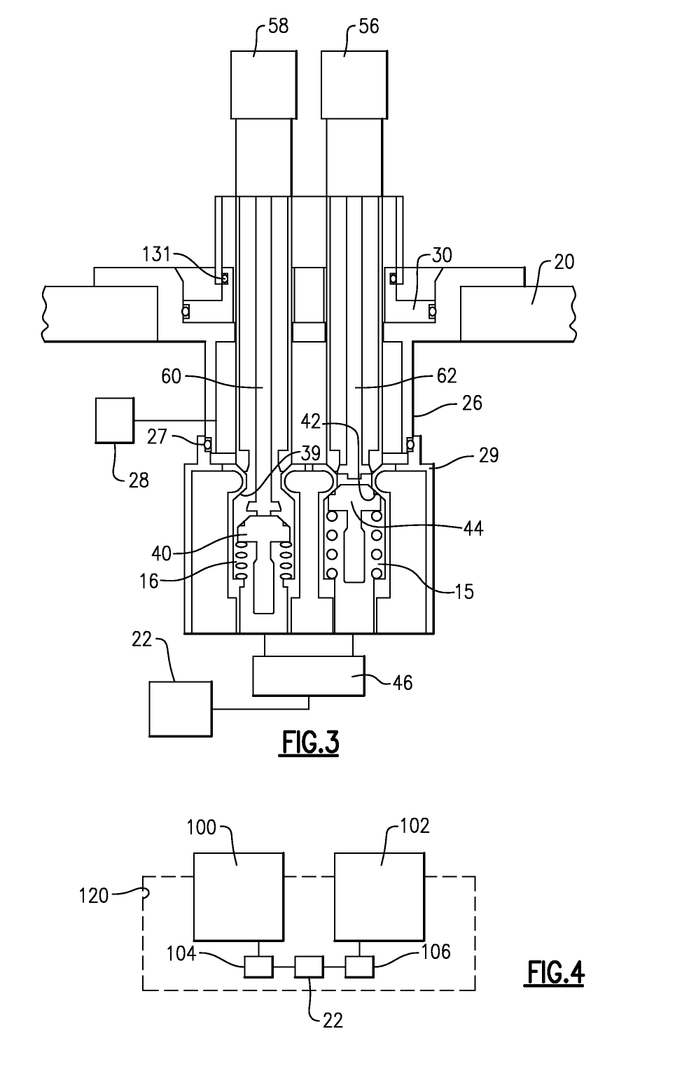

Fluid connections 15 and 16 communicate with the tank 46. The fluid connections include valve members (poppets) 40 and 44 which seat against valve seats 39 and 42. A separate housing 26 is located on an opposed side of the valves 40 and 44 relative to the tank 46. A source of vacuum 28 is shown connected to the housing 26. In practice, the vacuum connection 28 may actually come with the service connection as illustrated in FIGS. 2 and 3. A seal 27 seals between housing 26 and storage tank 29.

A rotating cover plate 30 is shown closing off ports 32 and 34 into the housing 26. The plate 30 can be seen to have a fluid connection 36 which has been rotated out of alignment with one of the openings or ports 32 and 34.

As shown in FIG. 1, an arm 111 may move the plate 30 to rotate such that connection 36 and another such connection, not illustrated, align with ports 32 and 34 as shown in FIG. 2. The arm may be controlled robotically or by other means known in the art. In fact, the arm for turning the cover plate 30 may also be part of the service connection shown in FIGS. 2 and 3. The cover plate 30 may be provided with detents or other securement structure to maintain it in the position of FIG. 1 until rotated to the FIG. 2 position. FIG. 2 shows a service connection 54 connected to the plate 30. Two fluid connections 58 and 56 are associated with the service connection 54.

As shown in FIG. 3, poppet members 60 and 62 may be driven outwardly of the service connections 58 and 56 to move the valves 40 and 44 away from the sealed positions. In this position, fluid can be supplied such as from the connection 58 into the tank 46 while a vent connection is provided through the connector 56 to allow air or other gas to be removed as the fluid fills the tank 46.

FIG. 4 shows a practical embodiment 120 having two service connections 100 and 102, which may be identical to those described above. The fuel cell 22 communicates with tanks 104 and 106 associated with the two service connection systems 100 and 102. It should be understood that one of the tanks 104 and 106 may contain a fuel such as hydrogen while the other would contain oxygen.

During the entire operation illustrated across FIGS. 1, 2 and 3, a vacuum 28 may be drawn on the interior of the housing 26. Due to this vacuum, there will be less leakage fluid left around the valves after completion of the service or filling. This will decrease the likelihood of freezing and address the problems mentioned in the Background of the Invention section.

The output of the vacuum may be monitored to detect leaking, and thus provide an indication of a failure or faulty valve connection.

The present invention, thus, provides for a service connection that is less likely to experience the concerns mentioned above.

Although an embodiment of this invention has been disclosed, a worker of ordinary skill in this art would recognize that certain modifications would come within the scope of this invention. For that reason, the following claims should be studied to determine the true scope and content of this invention.

1. A system comprising:
a cryogenic tank and a connection for supplying a first fluid to said cryogenic tank; and
said connection provided with at least one valve which may be selectively opened to receive the first fluid, and a vacuum chamber housing positioned on an opposed side of the at least one valve from said tank with said vacuum housing being connected to a vacuum source operable to remove any fluid from said vacuum housing while the first fluid is being supplied through said at least one valve to said tank.

2. The system as set forth in claim 1, wherein there are at least a pair of said valves.

3. The system as set forth in claim 2, wherein said connection includes a supply connection and a vent connection.

4. The system as set forth in claim 1, wherein said connection includes a pair of connections.

5. The system as set forth in claim 4, wherein a tank is associated with each of said pair of connections, one of said tanks supplying cryogenic hydrogen and the other of said tanks supplying-cryogenic oxygen for use in a fuel cell.

6. The system as set forth in claim 1, wherein said at least one valve includes a bayonet connection.

7. The system as set forth in claim 6, wherein a poppet member extends through said vacuum housing to move said valve away from a valve seat to allow flow of the fluid to the tank.

8. The system as set forth in claim 7, wherein there are a pair of valves, and a pair of poppet members extending through said vacuum chamber, with one of said valves receiving a fluid to pass to said tank, and a second of said valves allowing venting of the tank.

9. A method of supplying fluid to a cryogenic tank comprising the steps of:
attaching a connection to a cryogenic tank;
opening a valve and supplying cryogenic fluid to said tank;
providing a vacuum chamber housing positioned on an opposed side of a valve from said tank, and pulling a vacuum within said vacuum housing to remove fluid from said vacuum housing while cryogenic fluid is being supplied through said valve to said tank.

10. The method as set forth in claim 9, wherein there are at least a pair of said valves.

11. The method as set forth in claim 10, wherein fluid is also vented through a second valve while fluid is being supplied.

12. The method as set forth in claim 10, wherein there are a pair of said connections a tank is associated with each pair of connections, one of said tanks supplying cryogenic hydrogen and the other of said tanks supplying cryogenic oxygen for use in a fuel cell.

13. The method as set forth in claim 10, wherein a poppet member extends through said vacuum housing to move said valve away from a valve seat to allow flow of the fluid to the tank, and wherein there are a pair of valves, and a pair of poppet members extending through said vacuum chamber, with one of said valves receiving a fluid to pass to said tank, and a second of said valves allowing venting of the tank.

14. The method as set forth in claim 9, wherein an output of the vacuum is monitored to identify a failing or faulty valve.

15. The method as set forth in claim 9, wherein said connection includes a rotating cover plate which is rotated away from a closed position to allow the supply of cryogenic fluid, and rotated to a closed position after the end of the supply.
